(19) United States
(12) Patent Application Publication
(10) Pub. No.: US 2009/0191803 A1
(43) Pub. Date: Jul. 30, 2009

(54) FUME HOOD SYSTEM HAVING AN AUTOMATIC DECOMMISSION MODE

(75) Inventors: Jeremy R. Barrette, Fitchburg, MA (US); Bing Liu, Lexington, MA (US); Wei Hua, Acton, MA (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/019,223

(22) Filed: Jan. 24, 2008

(51) Int. Cl. B08B 15/02

(52) U.S. Cl. 454/56

(57) ABSTRACT

A fume hood system having a decommissioned mode. A fume hood may be required to maintain a minimum flow from its enclosure holding fume type substances via an exhaust external to the hood. However, if the fume hood is considered not in use or not containing fume type substances, it may be put into a decommissioned mode not necessarily having a flow requirement. This mode may be entered by pressing a sequence of buttons on a monitor, operating a switch, receiving a signal from a building management system, or the like, provided that certain criteria for non-use are met by the fume hood. The decommissioned mode may also be entered or exited automatically. Status of the fume hood, as to in-use or decommissioned, may be reported to a building management system for monitoring, reporting, and/or command purposes.

### BACKGROUND

The invention pertains to fume hoods and particularly to the energy-efficient operation of fume hoods.

### SUMMARY

The invention is a fume hood system having an easily implementable and optionally automatic decommission mode.

### BRIEF DESCRIPTION OF THE DRAWING

FIG. 1 is a block diagram of a fume hood system;

FIG. 2 is a diagram of a variable air volume fume hood;

FIG. 3 is a diagram of a variable flow fume hood;

FIG. 4 is a diagram of fume hood having a series airflow control valve for providing a steady constant exhaust flow independent of duct pressures;

FIG. 5 is a diagram of a fume hood having a two-state airflow control valve;

FIG. 5a is a diagram showing the inside a fume hood enclosure; and

FIG. 6 is a flow diagram of fume hood monitor signals.

### DESCRIPTION

Some fume hood systems in general may be described in U.S. Pat. Nos. 4,528,898; 4,706,553; 4,773,311; 4,893,551; 5,117,746; 5,240,455; 5,385,505; 5,545,086; 6,137,403; 6,914,532; 6,935,943; 6,960,126; and U.S. patent application Ser. No. 10/838,409. U.S. Pat. Nos. 4,528,898; 4,706,553; 4,773,311; 4,893,551; 5,117,746; 5,240,455; 5,385,505; 5,545,086; 6,137,403; 6,914,532; 6,935,943; and 6,960,126 are hereby incorporated by reference. U.S. patent application Ser. No. 10/838,409, filed May 4, 2004, is hereby incorporated by reference. The assignee of these patents and application may be the same as the assignee of the present application.

With energy costs staying at high levels, the cost to heat, cool, condition, and move one CFM of air each year may be relatively expensive. Every CFM of supply air that can be saved safely in laboratories, or other spaces, may provide instant savings for users. The present fume hood system may have energy-saving elements which includes fume hood decommissioning. This element may be standard and selectable (on/off) during commissioning.

Chemical fume hoods in a use status are generally suggested by law, such as a code or regulation, to maintain certain minimum volumes of exhaust air flowing through them when they contain fume-emitting chemicals. However, when there are no chemicals present in the hood, the exhaust flow may be reduced below these values, even below required standby values. Doing so may provide energy savings by reducing the amount of conditioned air that is exhausted out of the laboratory. As to other known fume hoods, this approach must be done manually in such way as removing power from the hood and its associated control system. Once a fume hood is decommissioned by such approach, it cannot necessarily respond with a safe exhaust flow if someone places chemicals within the hood without a person first manually reversing the decommission process. The present hood system may avoid these inconvenient manual approaches with automatic reversing of the decommission process.

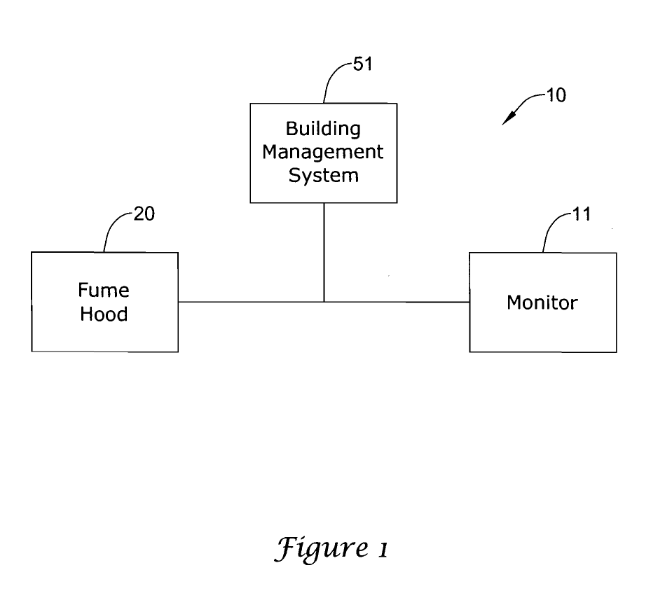

FIG. 1 is a block diagram of a fume hood system 10 having a fume hood 20 and a monitor 11 connected to each other. A building management system 51 may be connected directly or indirectly to the monitor 11 and fume hood 20. Monitor 11 may communicate with fume hood 20 in a wireless or non-wireless manner.

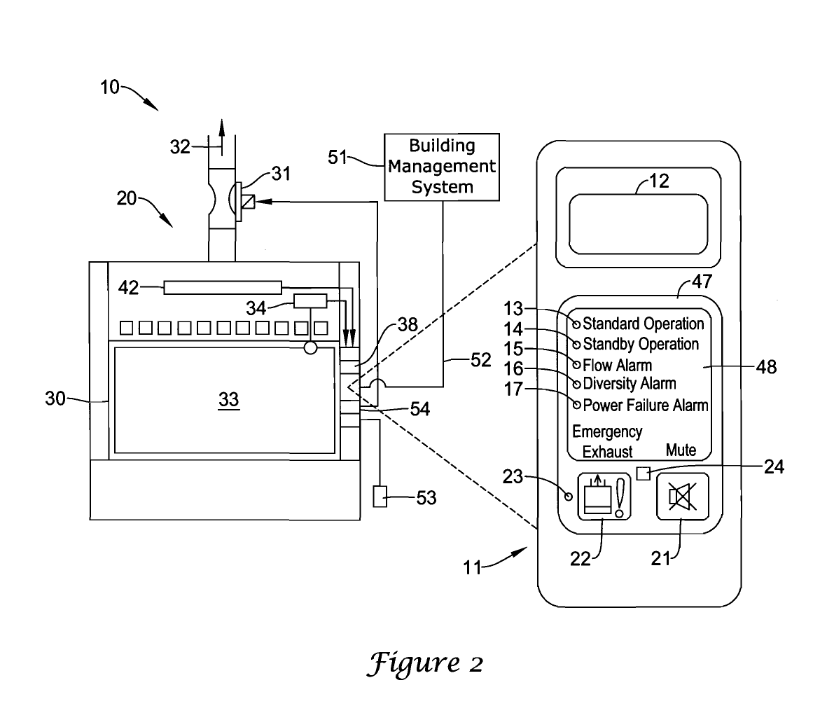

System 10 may have a fume hood 20 which can be manually or automatically decommissioned via the fume hood control system. The system may incorporate an automated control mechanism. Fume hood controls to initiate a decommission mode, safety, alarming and notification may be designed into the system 10. By integrating the fume hood information with an air or building management system 51, a building owner or manager may be notified when a fume hood 20 is decommissioned by the present fume hood system 10. Also, the present system may initiate the decommission mode remotely and/or automatically. The fume hood control system 10 may automatically return to normal safe exhaust flow when someone, for instance in FIG. 2, moves the sash 33 aside or up, and places chemicals within the fume hood enclosure 30. There may be an automatic sash 33 closing mechanism.

A fume hood monitor 11 of the fume hood system 10 may have a circuit to receive a switch input to initiate a decommission command, a software algorithm to determine if the hood sash 33 is fully closed, and an output to send a signal to the hood exhaust valve to move it to its minimum flow position. For shut-off valves, this may be the shut-off position (e.g., about zero CFM flow). For standard valves, this may be the specified minimum position. The monitor 11 may also be considered as a controller (viz., a monitor/controller) even though referred to as a “monitor”.

The decommission mode may be commanded from one of several sources. One may be a sequence of pushbuttons on the faceplate 47 of the fume hood monitor 11, or a special decommissioning button on monitor 11. Another may be a momentary external switch 53 to one or multiple hoods. Still another may be a latched switch command received from the building management network 52 or system 51 for one or several hoods. Other ways may be implemented to command or initiate the decommission mode. The system 10 or fume 20 may also be referred to as entering or exiting the decommission mode or decommissioned mode. The status regarding this mode may be expressed with various terminologies in the present specification.

A failsafe may be built into the control sequence such that the hood sash 33 is effectively closed to permit commanding the hood into a decommission mode, and if the sash is subsequently raised, the fume hood monitor 11 may automatically exit decommission mode and return to normal operation. This is to ensure the proper containment of fumes within the hood enclosure 30 if someone opens the hood and places chemicals within the enclosure when it is decommissioned. If the hood sash 33 is subsequently fully closed again, the fume hood 20 may or may not automatically re-enter decommission mode. If not, then the decommission mode may be reinitiated.

The fume hood monitor 11 may display a message of “OFF” to indicate that hood 20 is decommissioned. An alternate means, such as a light, LED, and so forth, may also be used for indication. An exhaust valve controller may report via the building management network 52 to the building management system (BMS) 51 that the hood 20 is decommissioned.

Another approach of the invention may use the input from a zone presence sensor (ZPS) 42 to override the decommission mode. The zone presence sensor may determine when a person is present at the fume hood 20.

Another approach of the invention may include using a valve controller 54 to control the decommission mode, receive a switch input, and provide a message to the fume hood monitor 11 for notification. Valve controller may be situated in fume hood 20, as shown in FIGS. 2-5, or in monitor 11.

Another approach of the invention may be to use a room controller (which may represent the monitor 11 and/or building management system 51) to effect or control the decommission mode, receive a switch input, command the exhaust valve to a greater or lesser closure value, and provide a message for notification of the mode.

Usage-based controls equipment may be noted. For variable air volume (VAV) systems, a sash sensor 34 may be provided to measure the height of a vertically moving fume hood enclosure sash if applicable. A sash sensor 34 may also be provided for a horizontal moving or overlapping sash. Sash 33 may be configured horizontally or vertically on hood enclosure 30. The sash sensor 34 may be for determining an amount that the sash is open.

The presence and motion sensor or the zone presence sensor 42 may be provided to determine an operator's presence in front of hood 20 by detecting the presence and/or motion of an operator, and in absence of such presence and motion to command the fume hood airflow control system from an in-use operating air flow or face velocity (e.g., 100 fpm) to a standby face velocity (e.g., 60 fpm) and vice versa. There may be a sensor or sensors in the hood enclosure 30 or exhaust mechanism or tube for detection and measurement of airflow or face velocity. Information from such sensor or sensors may be conveyed to monitor 11 and shown on display 12.

If a relevant portion or all of system 10 (fume hood 20, monitor 11 and/or BMS 51) meets the criteria as stated herein for maintaining a decommissioned mode and is in a standby mode for a configured period of time, then that portion of or all of system 10 may automatically enter the decommissioned mode. If a relevant portion or all of system 10 is in a normal operational mode and comes into non-use or disuse for a configured period of time and meets the criteria as stated herein for maintaining a decommissioned mode, then that portion of or all of the system 10 may automatically enter the decommissioned mode. The automatic entering the decommissioned mode may be configured within the system, and such automatic entering may be selected, elected or not.

The presence and motion sensor 42 may define an adjustable detection zone that extends approximately 20 inches (50 cm) from the front of the fume hood. If the sensor does not detect presence and/or motion in its detection zone within 30 to 3,000 seconds or so, it should command the system to the user-adjustable standby face velocity. When the sensor detects the presence and/or motion of an operator within the detection zone, it should command the system to implement the hood-in-use face velocity within 1.0 second, although it may be some other time length.

The presence and motion sensor 42 may sense an inanimate object when placed in the detection zone and remain in the standard mode of operation for 30 to 3,000 seconds or so, after which it will return to a standby mode. An operator may enter and leave the zone with the unit adjusting automatically between in-use and standby modes. If the inanimate object is moved or taken out of the zone, the unit may adapt to the change automatically. The standby mode is not a decommissioned mode. The 30 to 3,000 seconds is a range used for illustrative purposes, since the range may other than as indicated herein. The presence and motion sensor 42 may be configurable for varying levels of lighting intensity and motion sensitivity.

The presence and motion sensor may have the ability to operate on either AC or DC power sources. Relatively wide area motion detectors are not necessarily useful, whether situated on the hood or at a room level.

The presence and motion sensor should have an adjustable detection zone capable of covering a fume hood up to eight feet wide and be mounted from six to 12 feet above the floor surface. These dimensions are for illustrative purposes, as other magnitudes may be applicable and implemented.

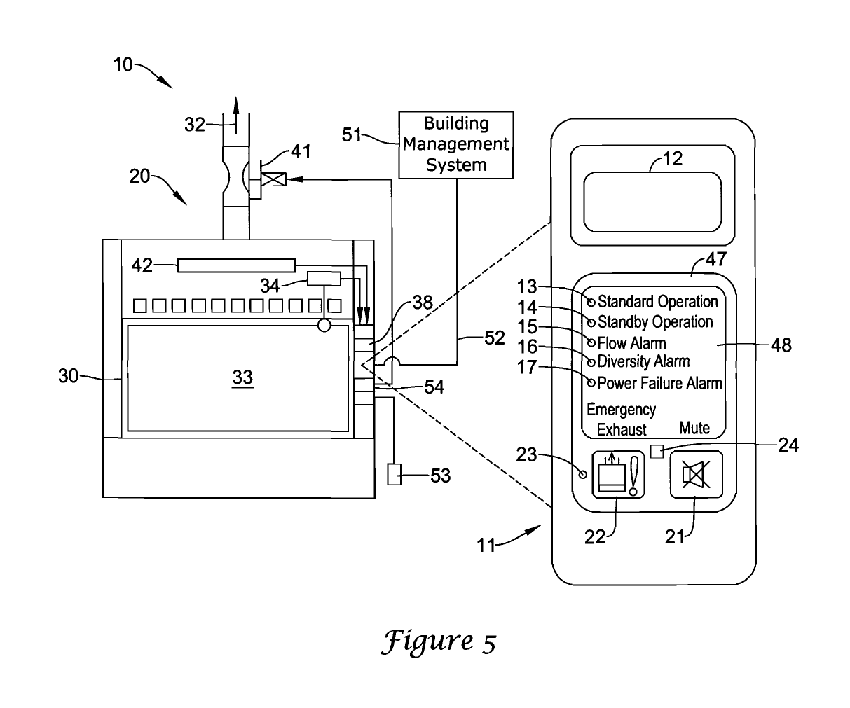

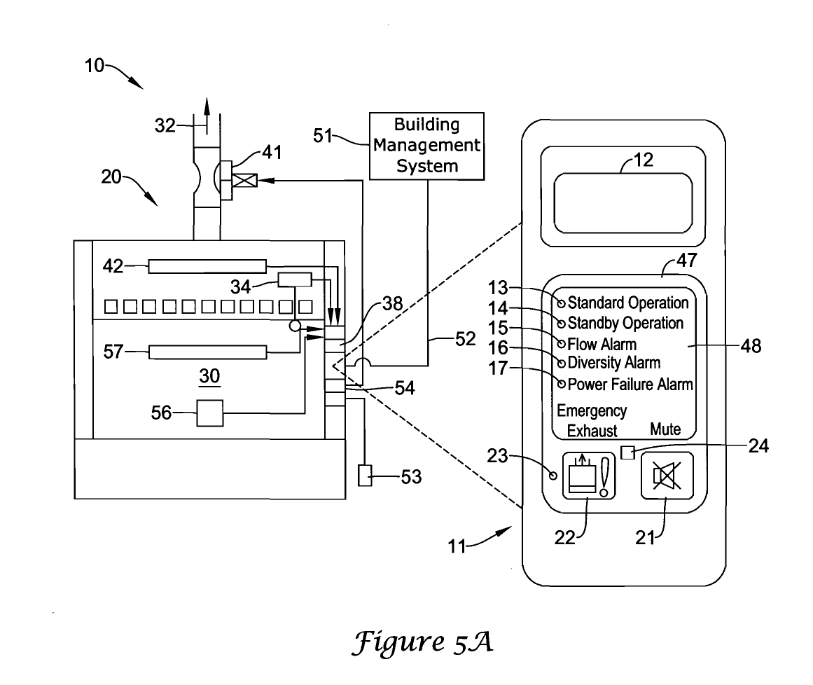

Also, hood 20 may have a fume sensor 56 inside the fume hood enclosure 30, as shown in FIG. 5a, that upon detection of chemical fumes provides a signal that causes the fume hood 20 to exit the decommission mode. FIG. 5a shows the inside of the fume hood enclosure 30 with the sash 33 either open or removed for illustrative purposes.

Also, hood 20 may have a sensor 57 inside the hood enclosure 30, as shown in FIG. 5a, that upon detection of the presence of laboratory equipment or chemical beakers, vials, and so on, within the hood enclosure 30, may provide a signal that causes the fume hood 20 to exit decommission mode.

The airflow at fume hood 20 may vary in a linear manner between adjustable minimum and maximum flow set points to maintain a constant face velocity throughout the range between the points. A minimum volume flow should be set to assure flow through the fume hood 20 even with the sash 33 fully closed.

The fume hood monitor 11 may be provided to receive a sash sensor 34 output, and a presence and/or motion sensor 42 signal. This same monitor may generate an exhaust airflow control signal for the appropriate airflow control device in order to provide a constant average face velocity. Audible and separate visual alarms may be provided for flow alarm and emergency exhaust conditions. The fume hood monitor 11 may incorporate the following capabilities. One capability is the LED display 12 to show one of the following measurements which may include cubic feet per minute (CFM), meters cubed per hour (m³/h), liters per second (l/s), feet per minute (fpm), and meters per second (m/s). The display may instead be an LCD or other type of display.

The monitor 11 may have an alarm muting, which silences the audible alarm for an adjustable time period, when the mute button is pushed. If another alarm is generated during the mute period, the new alarm may override the mute delay and sound an alarm again. There may be an auto alarm muting, which sets the alarm to mute automatically after 20 seconds or so.

The monitor 11 may have the emergency exhaust button 22 with the LED 23, which activates an emergency exhaust mode. In this mode, the exhaust air is at its maximum flow. When activated, the alarm may sound and the associated LED may flash. To activate the emergency exhaust mode, one may push the emergency exhaust button 22. Button 22 may be pushed again to cancel the emergency exhaust mode.

The flow alarm LED 15 may illuminate to indicate an unsafe airflow condition. The audible alarm may also activate and subsequently be muted. For example, there may be a broken retracting cable alarm in the case where the sash 33 is operated with the cable, which has an audible alarm with a flashing LED to indicate whether a vertical sash sensor cable is detached, thereby ensuring the fume hood users' safety.

The monitor 11 may have a diversity alarm that has a LED 16, which can be activated locally or from the building management system. An audible alarm will not necessarily be generated at the fume hood monitor relative to the diversity alarm.

The monitor 11 may have an energy waste alarm, which generates a local visual (e.g., display) and audible alarm to notify when the fume hood sash is open beyond its minimum position for being considered as closed (i.e., the sash is regarded as open) and the lights in the room are off. The lights being off may be indicative of a non-use status of the fume hood. When activated, the LED display 12 may show “ENRG” and the audible alarm will sound until the sash 33 is closed or lights turned on. Lights being off may imply non-use of the hood. The light levels at which the alarm is both initiated and cancelled may be configurable. On the other hand, as also configured, the lights being on may indicate a use of energy in the midst of a hood 20 not being used and thus trigger an energy waste alarm. A light sensor 24 may detect the light level in the room and trigger the energy waste alert, according to configuration specifications.

The new energy waste alert may be selectable during commissioning, in that can be enabled or disabled, and the light “on” and light “off” levels may be configured in the software or firmware.

The monitor 11 may have a fume hood decommissioning mode control, which commands the exhaust flow through the fume hood to the minimum allowed by the exhaust valve when the sash 33 is fully closed and no chemicals are present in the hood enclosure 30. The mode may be initiated by either pushbutton sequence on the fume hood monitor 11, external momentary switch 53 input to the fume hood 20 and monitor 11, or via a network 52 command. More specifically, when activated, the LED display 12 may show “OFF” and the exhaust valve of the fume hood 20 may move to its minimum position or shutoff position. A safety may be built into the decommission mode, where opening the fume hood sash 33 will automatically return the fume hood enclosure 30 exhaust 32 to an in-use operating volume as may be indirectly determined by the sash sensor 34 output. The fume hood 20 decommissioning may be an integratible point to the building management system 51.

A fume hood 20 decommissioning mode on the monitor 11 may allow the fume hood to be decommissioned when it is not in use and the sash is fully closed. The exhaust flow 32 may be reduced below the fume hood's minimum to the valve's minimum flow (e.g., 90 CFM for a 12-inch valve). Proper standard operating procedures should be in place for removing chemicals from the fume hood enclosure 30 before it is decommissioned.

The decommission mode may have the following aspects. If the hood 20 is intended not to be used for an extended period of time, it may be decommissioned, which will provide a significant amount of energy savings. As to basic functionality, the monitor 11 may generate a “decommission” command signal. During “decommission mode”, the hood enclosure 30 exhaust valve or fan may move to a specified minimum position. For shut-off valves, this may be the shut-off position. For standard valves, this may be the specified minimum position. For a dedicated exhaust fan and variable frequency drive (VFD), this may be a lower fan speed or off.

The “decommission mode” may be configurable during the monitor's calibration by adding a “decommission” parameter. Selection choices may include disable, enable through a network variable (a network command received from the VC (valve controller), and energize the VC NC DO).

The “decommission mode” may be triggered, initiated or entered while the fume hood sash 33 is closed (i.e., less than a minimum sash position plus some dead band)—if the sash 33 is opened during “decommission mode”, the fume hood enclosure 30 exhaust valve may return to normal operation as a safety precaution when the hood 20 is not in emergency override. If the emergency button 22 is pushed during “decommission mode”, then the fume hood enclosure 30 exhaust valve may go to the full flow emergency position, with appropriate visual and audible alarms of monitor 11.

An indication during “decommission mode” may include the display 12 of the monitor 11 showing “OFF”. The actual sash 33 position may continue to be reported and the previously existing alarms may remain. If the hood 20 is in emergency override when “decommission mode” is initiated, then the hood 20 may remain in emergency. If the sash 33 is raised while in decommission mode, the fume hood monitor 11 and fume hood 20 may immediately return to normal operation. The monitor 11 and hood 20 may remain in normal mode regardless of sash 33 position, even if closed, until the decommission command is re-initiated. If a non-emergency alarm is found while the hood 20 is decommissioned, this alarm may sound at the monitor 11 and the appropriate LED may be lit as normal. The mute button 21 may function normally. However, the non-emergency alarm does not necessarily affect the decommission mode.

Exiting the “decommission mode” may be caused by pushing or turning the external momentary switch 53 again, pushing the button sequence again on the monitor 11 face plate 47 in FIG. 1; issuing a “return to normal flow” command from the building management system 51, moving the sash 33, or pushing the emergency button 22. After leaving the “decommission mode”, the monitor 11 may display whatever condition or state is in effect at the time “decommission mode” is exited.

The fume hood monitor (FHM) 11 may be used on fume hoods with valves or a dedicated exhaust fan for airflow control. Airflow control on these fume hoods may be achieved with the use of constant volume valves (CVV), two-position valves (PEV or BEV), variable air volume valves (VAV), or a variable frequency drives (VFD) and dedicated exhaust fans. Each monitor 11 may provide two primary functions—an indication of hood 20 exhaust operating condition and alarming. In manifolded VAV or dedicated fan systems, each monitor may also provide face velocity control and various energy-saving features.

Enclosure 30 may have various dimensions and specifications selected for the tasks to done with the fume hood 20. The system 10 may have, for instance, an operating range of 32 to 122 degrees F. (0-50 deg C.) ambient, and operate under conditions of 10 to 90 percent relative humidity (RH), non-condensing, and about 8200 feet (2500 m) altitude. The power requirements for each unit may include 24 Vac, ±10 percent, 50-60 Hz, 10 volt amps (VA), ±15 Vdc, and ±5 percent, 220 milliamps (mA).

Power loss alarm for a ±15 Vdc powered monitor may indicate loss of power to the fume hood system 10. During power failure, a red LED may flash once every four seconds or so, accompanied by short audible alarm “chirp”. The alarm may continue for at least 64 hours or until power is restored.

Features of the monitor 11 of FIG. 1 may include the display 12 which indicates face velocity or airflow of the hood. A calibration mode button, which can be actuated in an area 48 on the faceplate 47, but is not necessarily visible from the faceplate, may be used to enable and disable the calibration mode. There may be a standard operation LED 13 which indicates that the hood is operating at a standard face velocity or flow. A standby operation LED 14 may indicate when the hood 20 is operating at a lower face velocity or airflow (active with a ZPS 42). A flow alarm/drive failure LED 15 may indicate an unsafe airflow condition when hood 20 is functioning.

A diversity alarm LED 16 may alert lab users of numerous hoods 20, for example in a lab, to reduce the total flow by closing their sashes 33. The visual alarm 16 may be triggered when the flow demand exceeds the flow limit and the diversity alarm is generated by the building management system 51 or another system.

The power failure alarm LED 17 may activate when there is a loss of power. It may be used with the power loss alarm. The power loss alarm may have a sealed lead acid battery that uses +15 Vdc for recharging while the system is powered. The battery may recharge sufficiently in about 8 hours to power the alarm circuit for 24 hours. The battery's expected service may be about five years. Other kinds of batteries or power sources may be used. The power loss alarm may detect the loss of the ±15 Vdc system power. The voltages and the kind of power may be different for the present example. The alarm may trip a solid-state relay that causes the battery to provide power to the monitor's alarm circuit. The circuit may drive the audible alarm and an LED 17 on the monitor 11 to indicate a loss of power. The power loss alarm may include a test button (not shown) which if pushed for at least four or so seconds, cuts the system's power, trips the relay and tests the battery and alarm circuitry.

There may be the mute button 21 which can silence an alarm when pushed; however, in this situation, the flow alarm LED 15 will remain on. The mute mode may be reset when the alarm conditions clear. The emergency exhaust button 22 may be with the LED 23. Button 22 may be pushed to activate the emergency exhaust mode. An alarm may sound and the LED 23 at the left of the emergency exhaust button 22 may blink. In this mode, the exhaust air may be at its maximum flow, but on constant volume hoods, button 22 is generally used to test the alarm circuit, not to modulate or control the exhaust valve. Button 22 may be pushed again to turn off the emergency exhaust/test mode.

FIG. 2 is a diagram of a variable air volume (VAV) fume hood 20. It may have a hood exhaust valve 31 which may vary the flow 32 out of the hood from 200 to 1000 CFM in this particular example. Fume hood enclosure 30 containment may be achieved by maintaining proper face velocity through a sash 33 having a variable opening which may be detected by a sash sensor 34. A sash 33 opening alarm may be used with the sash sensor or sash switch 34. The variable air volume fume hood 20 and monitor 11 may be used on manifolded exhaust systems having other hood systems having valves 31.

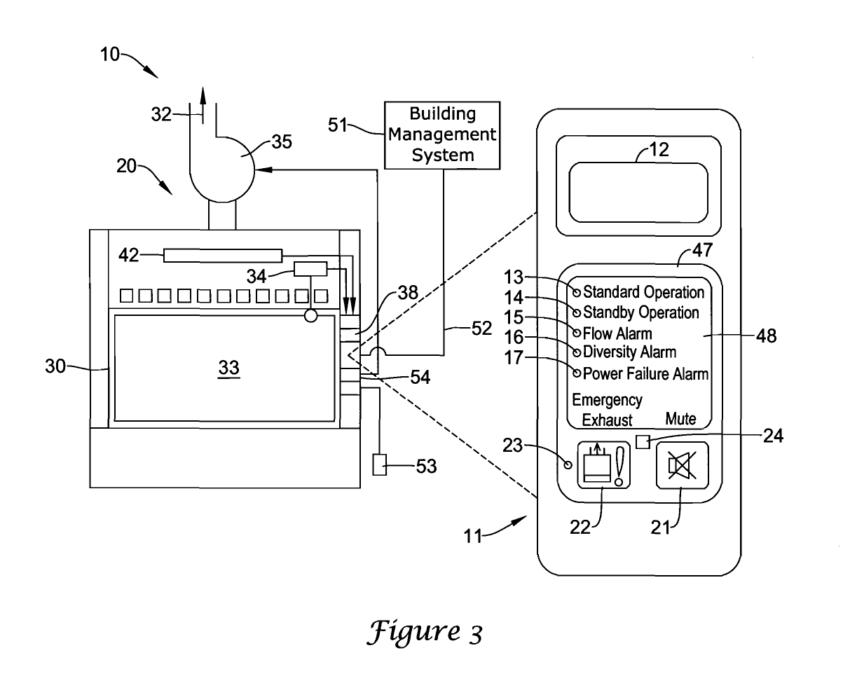

An individual exhaust system may be of a fume hood 20 and monitor 11 having a variable speed drive blower 35, as in FIG. 3 which is a diagram of a variable flow fume hood 20. It may have a variable speed drive blower 35 which may provide a flow 32 out of the hood enclosure 30 from 200 to 1000 CFM in this example. Depending on the size of the hood enclosure 30, the flow amount and variation may be different from the present examples.

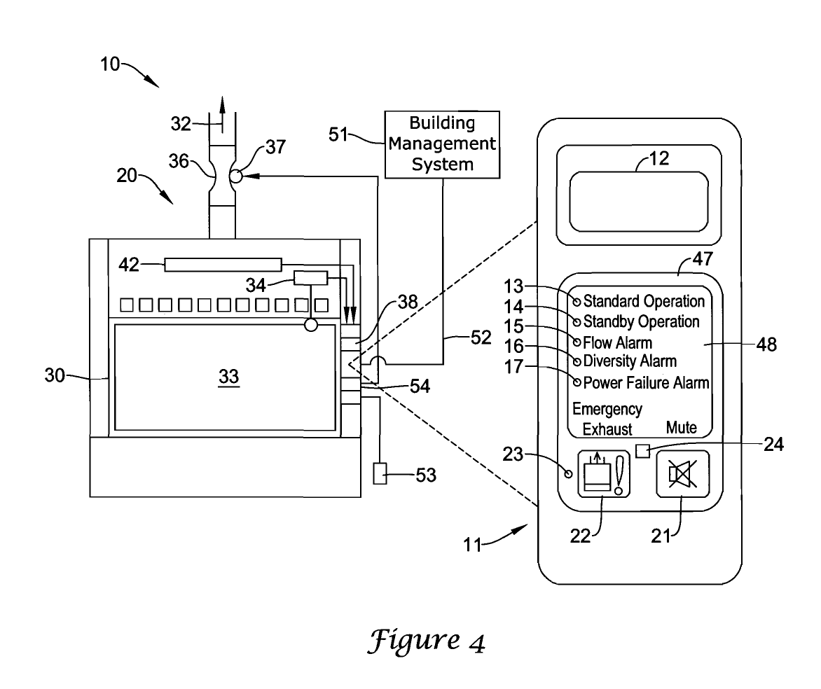

FIG. 4 is a diagram of fume hood 20 and monitor 11 where the system may have a series airflow control valve 36 which provides a steady constant exhaust flow 32, independent of duct pressures, to a manifold. There may be an alarm 38 together with a differential pressure switch 37 mounted on the airflow control valve 36 to indicate the fume hood's operation. The flow 32 may be achieved with a fume hood valve set at 1000 CFM. For other kinds of fume hoods, the flow 32 may be of another magnitude.

FIG. 5 is a diagram of a fume hood 20 having a two-state airflow control valve 41 which may provide a two-position exhaust control based on an operator's presence at the fume hood enclosure 30. The two-position exhaust control may be achieved with a zone presence sensor 42 and the series airflow control valve 41 with an on-board solenoid. Other switching mechanisms such as a sash sensor 34 may be applied. The two states of fume hood exhaust flow 32 may be, for instance, 600 and 1000 CFM. The two states may have other magnitudes depending on the design of the fume hood enclosure 30.

Under many conditions, the face velocity may be set back to provide safe containment when the hood enclosure 30 is vacated. The setback face velocity may be adjustable to field conditions which can typically be between 60 and 100 fpm (0.3-0.5 m/s).

A goal may include maintaining a constant face velocity (FV) as the sash 33 opening varies. Since the face velocity set point may be known, a change in sash 33 area can cause a linear change in exhaust flow (i.e., Area×FV=Flow command). For instance, 5 ft²×100 ft/min=500 ft³/min, or 0.5 m²×0.5 m/s×3600 s/hr=900 m³/hr.

Under many conditions, the face velocity may be set back to provide safe containment when the hood enclosure 30 area is vacated. Setback face velocity may be adjusted to field conditions.

Monitor 11 may provide indications of a fume hood's operation. Alarms of the monitor 11 may indicate insufficient differential static pressure as detected by the valve's pressure switch and/or incorrect airflow (i.e., sash command≠closed-loop feedback).

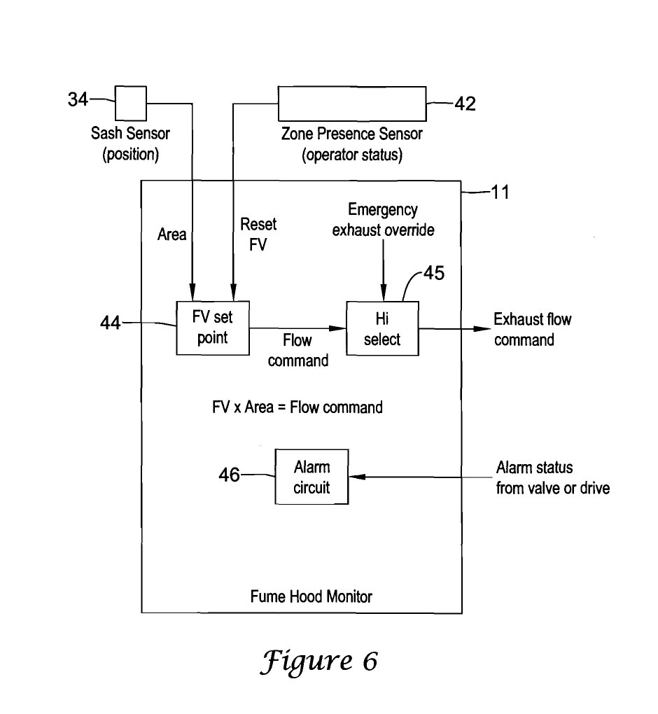

FIG. 6 is a of a VAV fume hood monitor 11 signal flow diagram. The sash sensor 34 may provide position information in terms of area to a face velocity (FV) set-point module 44. The zone presence sensor 42, indicating operator presence or status and other ambient conditions about hood 20, may provide reset face velocity information to module 44. Module 44 may output flow command information to a Hi select module 45. Also, emergency exhaust override information may be input to module 45. Module 45 may output exhaust flow command information. Alarm status information from a valve or drive may be input to an alarm circuit module 46.

Existing codes typically suggest that a fume hood 20 maintain a minimum exhaust equal to 50 CFM/ft. of hood enclosure 30 width or 25 CFM/sq. ft. of work surface area. However, these codes may also permit the minimum exhaust flow to be reduced below this value when the hood is not in use (i.e., no chemicals present within the hood enclosure 30). Several excerpts from two standards and/or guidelines address this topic. ANSI/AIHA Z9.5-2003, Section 3.3.1, indicates that “The mechanism that controls the exhaust fan speed or damper position to regulate the hood exhaust volume shall be designed to ensure a minimum exhaust volume in constant volume systems equal to the larger of 50 CFM/ft. of hood width, or 25 CFM/sq. ft. of hood work surface area, except where a written hazard characterization indicates otherwise, or if the hood is not in use.” NFPA 45-2004, Section 8.2.2, indicates that “Laboratory units and laboratory hoods in which chemicals are present shall be continuously ventilated under normal operating conditions.”

The present fume hood system 10 may have a mechanism to decommission fume hoods 20 through a hood control system 11 when there are no chemicals present in the hood enclosure 30 and the sash 33 are closed. Exhaust flow 32 from the hood enclosure 30 may be reduced below the hood minimum to the valve minimum and the zone balance function may actively adjust the supply and general exhaust accordingly to maintain offset, temperature control, and air changes per hour (ACH) automatically.

The fume hood 20 decommission mode on the monitor 11 may command the exhaust valve to its specified minimum position. The shut-off valves may be in the shut-off position and the standard valves may be set at a specified minimum position. This function may be with an associated valve controller 54 and be selectable during commissioning. It may be enabled or disabled.

During the decommission mode, the monitor display 12 may show “OFF” and the standard operation LED 13 will not be lit. The monitor alarms may continue to function (emergency exhaust, jam, and so forth). In addition, there may be a reportable point available on the valve controller 54 for integration to the building management system 51.

The decommission mode may be initiated in one of several ways. One way is with a pushbutton sequence on the fume hood monitor 11 faceplate 47. One may hold down the mute 21 and emergency exhaust 22 buttons for about three seconds or so. One may press the mute button 21 first before pressing and holding the emergency exhaust button 22; otherwise, the monitor 11 may tend to go into a local emergency mode immediately (because of a nuance) due to the fact that emergency exhaust button 22 is handled first in the system. During the face plate 47 button sequence, the monitor display 12 may show or flash “OFF?” to prompt the user for confirmation. The user may confirm by pressing the mute button 21 again. If the second mute button 21 press is not done, then the decommission command may be cancelled.

Another way to initiate the decommission mode may be via an external momentary pushbutton or key switch 53. A momentary pushbutton switch or spring-loaded key switch 53 may be used. A single beep at the monitor 11 may notify the user that the fume hood 20 has been decommissioned. Multiple hoods may be wired to one external switch 53. Other mechanisms may be implemented in the present system 10 for initiating the decommission mode.

Still another way to initiate the decommission mode may be a command from the building management system 51 via network 52. It may be enabled through a network variable (a building management system 51 command). A network 52 promulgated command, for instance, nviRemoteDI[0], written from the building management system 51 to the valve controller 54, may energize the valve controller 54 physical DO. Its data type may be, for instance, UNVT_Phx_Switch. A value of TRUE (1) may command the monitor 11 valve controller to enter the decommission mode and a value of FALSE (0) may command the controller 54 to exit the decommission mode. These or other commands and types may be used in the present system 10.

Integration of a decommission mode in to the fume hood system 10 may be effected. nvoRemoteDO[0] may be used as decommission mode status indicator. (This point may be available in each of the methods of initiation.) Again, its data type may be UNVT_Phx_Switch. The value text, “tpData_Phx_Switch 1,” may indicate that the fume hood 20 is in the decommission mode, while “tpData_Phx_Switch 0” may indicate that the hood 20 is in a normal mode. The default initial value may be “tpData_Phx_Unused 0.” Other command and type terminology may be utilized in the system 10 for initiating or exiting the decommission mode, recognizing the normal mode of the fume hood 20, and so forth.

The decommission mode should only be triggered when the fume hood enclosure sash 33 is virtually fully closed and the fume hood 20 is not in emergency override. The decommission mode may be exited in one of several ways. One way is if the sash 33 is opened more than five or so percent during the decommission mode, the fume hood monitor 11 and valve controller 54 may return to normal operation as a safety precaution. The hood 20 will not necessarily return to the decommission mode automatically if the sash 33 is subsequently closed; the decommission mode must be initiated or commanded again, or automatically be a result of certain criteria being met over a certain configured period of time.

Another way may be if the emergency exhaust button 22 is pushed during the decommission mode, the fume hood monitor 11 and valve controller 54 will go to the full-flow emergency position, with the appropriate visual and audible alarms, thus exiting the decommission mode. If the emergency exhaust button 22 is pressed again, the hood 20 may return to normal operation and will not necessarily resume the decommission mode; the decommission mode may need to be initiated or commanded again, unless put into an automatic approach as indicated herein.

Still another way may be if the external momentary switch 53 is opened (if configured as such). Yet even another way may be if the building management system 51 writes the nviRemoteDI[0] to FALSE (0) (if configured as such). When decommission mode is commanded by the building management system 51 and is exited by sash movement or emergency exhaust, the hood 20 will not necessarily return to the decommission mode automatically, unless otherwise configured, even if nviRemoteDI[0] is still TRUE (1). The building management system 51 may need to reissue a decommission command by toggling nviRemoteDI[0] to FALSE (0) first, then back to TRUE (1).

A valve controller 54 design for the decommission mode may include a configuration property added to the hood 20 functional object (hood.nxe), which is UCPT_HDMntrCfg.nCtrlByte.bDeCommEbl-TRUE to an enabled decommission mode. The default value may be FALSE (disabled). When using the hood application image in the current valve controller 54, users may directly modify UCPT_HdMntrCfg.nCtrlByte.bUnused to enable the decommission mode manually by setting this configuration property to TRUE in a LonWorks™ browser. If the hood 20 valve controller 54 is in the decommission mode, then the following actions taken by the valve controller may include a valve driven to a first position which is either a shut-off or minimum flow position. The status variable may be nvoPhx.Status.ubMode.nDevMode=tpDev_DeCommissioned (14). Another status variable may be nvoRemoteDO[0]=tpData_Phx_Switch 1. Other terminology may be used for indicating the status variables, configuration properties, commands, types, signals, and so on in the present system.

In the present specification, some of the matter may be of a hypothetical or prophetic nature although stated in another manner or tense.

Although the invention has been described with respect to at least one illustrative example, many variations and modifications will become apparent to those skilled in the art upon reading the present specification. It is therefore the intention that the appended claims be interpreted as broadly as possible in view of the prior art to include all such variations and modifications.

What is claimed is:

1. A fume hood system comprising:
a fume hood; and
an automated control mechanism; and
wherein the fume hood can enter a decommissioned mode if the fume hood is in a non-use status and meets certain criteria for maintaining the decommissioned mode.

2. The system of claim 1, wherein the fume hood enters the decommissioned mode with a key sequence of a monitor connected to the fume hood, a switch connected to the fume hood and/or monitor, a signal from a building management system to the fume hood and/or monitor, or the like.

3. The system of claim 1, wherein:
the fume hood comprises a sash;
if the sash is open beyond a configured amount, then the fume hood cannot enter the decommissioned mode; and
if the fume hood is in the decommissioned mode and the sash is opened beyond the configured amount, then the fume hood automatically exits the decommissioned mode.

4. The system of claim 1, wherein if the fume hood is in the decommissioned mode and enters a use status, then the fume hood automatically exits the decommissioned mode.

5. The system of claim 1, wherein if the fume hood is in the non-use status and meets criteria for maintaining a decommissioned mode for a configured period of time, then the fume hood automatically enters the decommissioned mode.

6. The system of claim 1, further comprising:
a zone presence sensor proximate to the fume hood; and
wherein if the fume hood is in the decommissioned mode and the zone presence sensor detects a person at the fume hood, then the fume hood automatically exits the decommissioned mode.

7. The system of claim 1, further comprising:
a presence sensor within an enclosure of the fume hood; and
wherein if the fume hood is in the decommissioned mode and the presence sensor detects laboratory equipment, chemical containers or other objects within the enclosure of the fume hood, then the fume hood automatically exits the decommission mode.

8. The system of claim 1, further comprising:
a chemical fume sensor within an enclosure of the fume hood; and
wherein if the fume hood is in the decommissioned mode and the chemical fume sensor detects chemical fumes present within the enclosure of the fume hood, then the fume hood automatically exits the decommission mode.

9. A fume hood system comprising:
a fume hood; and
a monitor; and
wherein the fume hood comprises:
an enclosure;
a sash for providing an opening to the enclosure;
an exhaust port attached to the enclosure; and
an air control mechanism proximate to the exhaust port; and
the monitor is connected to the sash and the air control mechanism; and
the fume hood can enter and exit a decommission mode.

10. The system of claim 9, wherein the monitor can control an amount of air flow by adjusting the air control mechanism and/or the sash.

11. The system of claim 9, wherein if criteria for maintaining the decommission mode of the fume hood are met, then the fume hood automatically enters the decommission mode.

12. The system of claim 9, wherein if an opening of the sash is greater than a minimum percentage of a total opening of the sash considered acceptable for the decommission mode and the fume hood is in the decommission mode, then the fume hood automatically exits the decommission mode.

13. The system of claim 12, wherein if the opening of the sash returns to or less than the minimum percentage of the total opening, then the fume hood will not necessarily reenter the decommission mode.

14. The system of claim 9, further comprising:
a zone presence sensor; and
wherein if the fume hood is in the decommission mode and the zone presence sensor detects a person proximate to the fume hood for a configured period of time, then the fume hood will automatically exit the decommissioned mode.

15. The system of claim 9, further comprising:
a presence sensor within an enclosure of the fume hood; and
wherein if the fume hood is in the decommissioned mode and the presence sensor detects laboratory equipment, chemical containers, or other objects within the enclosure of the fume hood, then the fume hood automatically exits the decommission mode.

16. The system of claim 9, further comprising:
a chemical fume sensor within an enclosure of the fume hood; and
wherein if the fume hood is in the decommissioned mode and the chemical fume sensor detects fumes present within the fume hood, then the fume hood automatically exits the decommission mode.

17. A method for operating a fume hood comprising:
providing a fume hood having an opening;
controlling airflow through the opening;
clearing substances from the fume hood; and
initiating a decommission mode of the fume hood.

18. The method of claim 17, wherein the decommission mode reduces the air flow through the hood opening to a level below legal code requirements for use or standby of the fume hood.

19. The method of claim 17, wherein the decommission mode is initiated during non-use of the fume hood enclosure.

20. The method of claim 17, further comprising initiating the decommission mode with a key sequence on a monitor connected to the fume hood, a switch connected to the fume hood and/or monitor, a command signal from a building management system to the fume hood and/or monitor, or the like.

21. The method of claim 17, wherein a detected presence of a person proximate to the fume hood terminates the decommission mode of the fume hood.

22. The method of claim 21, wherein if the detected presence of a person or the sash opening which terminated the decommission mode is removed, the fume hood does not necessarily reenter the decommission mode.

23. The method of claim 17, wherein a detected presence of laboratory equipment, chemical containers, or objects within an enclosure of the fume hood terminates the decommission mode of the fume hood.

24. The method of claim 17, wherein a detected presence of chemical fumes within an enclosure of the fume hood terminates the decommission mode of the fume hood.
